(19) United States
(12) Patent Application Publication
(10) Pub. No.: US 2008/0105445 A1
(43) Pub. Date: May 8, 2008

(54) MODULAR LANDSCAPER

(76) Inventors: Douglas C. Dayton, Harvard, MA (US); Sung Park, Waban, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/838,799

(22) Filed: Aug. 14, 2007

Related U.S. Application Data
(60) Provisional application No. 60/838,099, filed on Aug. 15, 2006.

(51) Int. Cl. A01D 34/54; A01D 42/06; A01D 34/00; A01B 76/00; E01H 5/00

(52) U.S. Cl. 172/105; 56/253; 56/289; 172/13; 37/196

(57) ABSTRACT

A modular landscaper uses oversized wheels to generate torque for turning one or more of several interchangeable modular landscape maintenance attachments. The landscaper provides a handle configured in relationship to the landscaper frame to allow an adult to normally walk behind the landscaper while applying a forward force by pushing on the handle that results in the wheels of the landscaper rolling along a landscape maintenance surface and generating torque that is transferred through a drive train to the one or more attached landscaping maintenance attachments. A drive train uses the rotational energy of the wheels to increase the operator pushing force to operate the maintenance attachment. Interchangeable attachments facilitate using the landscaper for a wide variety of landscaping maintenance tasks.

### CROSS-REFERENCE TO RELATED APPLICATIONS

This application claims the benefit of the following provisional application, which is hereby incorporated by reference in its entirety:

U.S. Provisional Application No. 60/838,099, filed Aug. 15, 2006.

### BACKGROUND

1. Field

The methods and systems of wheeled landscape maintenance disclosed herein relate to landscape maintenance apparatus. In particular, the methods and systems relate to improved methods and systems of converting torque to enable a landscape maintenance function.

2. Description of the Related Art

Many separate devices are used to accomplish the daily and seasonal tasks around the exterior of the home. For example, during the summer we use lawn mowers, edger trimmers, seed broadcasters, and the like. During the fall we use leaf blowers, leaf collectors, fertilizer spreaders, and the like. During the winter we use snow blowers, salt spreaders, motorized walkway snow brushes, and the like. And during the spring we use weed treatment and fertilizer spreaders, leaf cleanup devices, and a variety of other devices to get the home and garden ready for summer. Aside from the trouble and expense of owning, storing, maintaining, and operating all of these devices, they are generally powered by electric motors or other gas or combustion engines that are noisy and pollute the environment and pose certain environmental and personal hazards from the motors, their fuel, and their electric power supplies. Such motorized yard and driveway devices are also generally noisy, which especially in close suburban or urban settings may annoy family and neighbors as well as annoy and damage the hearing of the user of the devices.

Conventional wheeled reel mowers are well known to generally be limited in practical application to lawns of no more than approximately 5000 square feet. This is primarily based on the notion that the time and level of effort required to use a conventional reel mower to cut more than 5000 square feet in one mowing session is generally excessive. Therefore, lawns above 5000 feet are conventionally cut by powered mowers, typically rotary blade gas powered mowers.

### SUMMARY

Landscape maintenance is labor intensive. Even with gas or electric powered equipment, generally all landscaping activities must be manually executed. Additionally, landscaping involves temporarily controlling natural growth and outdoor processes that vary widely by season, geographic location, and the like, so techniques must be adjusted to the particular environmental conditions associated with the maintenance task. In addition, landscaping tastes vary widely, so manual control of equipment to get the desired results is the norm. Therefore, while gas or electric powered equipment may increase labor efficiency, they do not eliminate the human labor and operation requirement. The efficiency of powered landscape equipment is most noticeable for large landscaping projects, such as cutting several acres of grass, or sweeping a large parking lot; whereas the labor efficiency improvement over manually operated equipment is generally marginal for medium or small environments.

A potential benefit of gas or electric powered landscape equipment is a reduction in exertion to operate the equipment for long periods of time. Human-powered landscape equipment can be made highly efficient in converting an operator's effort of pushing the equipment over a surface into operating the equipment by applying principals of mechanics and dynamics in the design of the equipment. Such efficiency improvement may be gained without applying costly new technologies or materials. With improved efficiency, human-powered landscape equipment may be economically and beneficially applied to larger and more diverse landscaping tasks.

Landscaping also involves a wide variety of tasks, even when seasonal changes are not considered. A season such as summer involves lawn mowing, grass raking, seeding, fertilizing, liming, pesticide application, edge trimming, walk and drive sweeping and/or blowing, and the like. A season such as winter involves snow blowing, snow sweeping for light snow falls, ice melt dispensing, sweeping after ice has melted, and the like. Therefore, the variety of tasks, and the equipment to perform the tasks, increases even more with seasonal change. The wide variety of single season and year round landscape tasks may be serviced by a modular, high efficiency, human-powered landscape maintenance system. A common drive train may be adapted to support the necessarily wide variety of attachment for these and other diverse landscaping tasks.

A modular landscaping system may also provide benefits to home owners such as reducing the cost of ownership while offering the home owner the right landscape maintenance attachment for the job. Gone are the days of sweeping snow off of the driveway with the household broom. A modular, human-powered, landscaping system can also reduce storage and warehousing costs, and space needs associated with dedicated or even multi-function powered landscape equipment. Also, converting between a snow blower, mower, edge trimmer, and sweeper is not practical in a powered system, whereas such conversion is straightforward with a modular human-powered landscaping system.

In an aspect of the invention, a method of landscape maintenance may comprise axially attaching a plurality of wheels to a frame, the wheels rotating and generating torque upon movement of the frame; providing a functional shaft axially attached to the frame; delivering the generated torque to the functional shaft, thereby causing the functional shaft to rotate; and using the rotation of the functional shaft to enable a landscape maintenance function. In the method, the wheels may be oversized. The wheels may have a diameter of between about twenty-four inches and about twenty-nine inches. In the method, the frame may be configured to allow a walking operator to push the frame. The frame may be configured to allow the operator to push in multiple directions. In response to the multidirectional pushing force, the wheels may rotate due to friction between the wheels and a horizontal surface supporting the wheels, thereby causing the wheels to roll along the horizontal surface. The wheels may roll substantially in one or more directions induced by the multidirectional force. In the method, delivering the generated torque may include providing a drive train between a rotating portion of the wheels and the functional shaft. The drive train may operate in response to the rotation of the wheels and the functional shaft rotates in response to the operation of the drive train. The drive train may include a drive belt. The drive belt may be made of at least one material selected from the group consisting of plastic, metal, mesh, a polymer, and a composite. The drive belt may include regularly spaced ribs disposed perpendicular to a direction of motion of the belt. The ribs may engage a drive portion of the wheels that is adapted to increase frictional forces between the belt and drive portion. The drive train may be a continuous chain, and wherein the wheels including a sprocket for engaging the drive chain and the functional shaft includes a sprocket for engaging the drive chain so that as the wheels roll, the drive wheel sprocket turns, causing the engaged chain to rotate the functional shaft gear, thereby causing the functional shaft to rotate. The wheel may include a gear rotating with the wheel, and wherein the drive train is one or more gears disposed to allow teeth of at least one drive train gear to engage teeth of the wheel gear causing the drive train gear to rotate in response to the wheel gear rotating, and wherein the functional shaft is turned by a gear that is turned by one of the one or more drive train gears. The drive train may cause the functional shaft to fully rotate more than once for each rotation of the wheels. The drive train may cause the functional shaft to fully rotate once for each rotation of the wheels. The drive train may cause the functional shaft to fully rotate less than once for each rotation of the wheels. In the method, the functional shaft may engage a maintenance attachment, and wherein at least a portion of the maintenance attachment operates in response to the rotating functional shaft. In the method, the maintenance function may include one or more of reel mower, a reciprocating scythe, a rake, a twirling brush, a rotating feeder, pump, a generator, a fan, a snow blower, a snow thrower, an edger, a rotary blade mower, a rotating brush, and a debris blower. The reel mower may include an adjustable cutting height. The cutting height may be manually adjustable from 0.5 inches to 3.0 inches. The reciprocating scythe may include a plurality of blades. At least two of the plurality of blades may reciprocate in opposite directions. The rake may rotate along an axis perpendicular to a direction of motion of the frame, may rotate along an axis that forms an angle of less than ninety degrees with a direction of motion of the frame, may include tines adapted for raking grass, or may include tines adapted for raking leaves. The twirling brush may twirl around a vertical axis or twirl around a horizontal axis. The rotating feeder may include a distribution plate. The distribution plate may include feed dispersing ribs. The rotating feeder may further include a feed supply container supported by the frame. The feed supply container may provide feed to the distribution plate through a port positioned so that the feed is delivered by gravity to the distribution plate. A rate of feed delivery may be based at least in part on a rate of rotation of the plate. The feed may include one or more of grass seed, lime, fertilizer, insecticide, pesticide, weed killer, crab grass control, and broadleaf growth control. In the method, the pump is a paint spray pump, a liquid feed pump, and the like. The liquid feed may include one or more of fertilizer, weed killer, insecticide, pesticide, and water. In the method, the generator may be an electromechanical induction generator, may convert the rotation of the functional shaft into electricity, may charge a battery, or may be a static electricity generator. The method may further include an electric motor for providing additional power to the functional shaft, wherein the electric motor is powered by the battery, and wherein the operator selectively engages the electric motor. The static electricity generator may further include a work light, wherein the work light illuminates in response to the static electricity. The work light may illuminate a portion of the surface in front of the system. In the method, the fan moves air toward the operator. In the method, the snow thrower may include a first stage snow collector and a second stage snow expeller. The snow collector may lift the snow into an expeller stage and wherein the expeller disperses the snow in the expeller stage away from frame. The operator may determine the expeller dispersal direction. The rotating brush may be substantially cylindrical, and wherein the brush rotates around the long axis of the cylinder formed by the rotating brush. The brush may rotate in the same direction as the drive wheels direction of rotation, or may rotate in a direction opposite to the drive wheel direction of rotation. The method may further include a second functional shaft axially attached to the frame, the second functional shaft being rotated by the drive train. The rotation of the second drive train may be converted into a second landscape maintenance function. The second landscape maintenance function may include one or more of reel mower, a reciprocating scythe, a rake, a twirling brush, a rotating feeder, pump, a generator, a fan, a snow blower, a snow thrower, an edger, a rotary blade mower, a rotating brush, and a debris blower. The method may further include a receptacle supported by the frame for receiving debris from the maintenance function. In the method, the frame may be configured to allow a walking operator to pull the frame. The frame may be configured to allow the operator to pull in multiple directions. In response to the multidirectional pushing force, the wheels may rotate due to friction between the wheels and a horizontal surface supporting the wheels, thereby causing the wheels to roll along the horizontal surface.

In another aspect of the invention, a modular landscape maintenance system may comprise a frame for receiving an operating force; two wheels rotating about an axle secured to the frame, the wheels rotating in unison in response to the operating force, causing the system to roll on the wheels along a surface; a drive axle for activating a maintenance adaptor that is attached to the frame, the maintenance adaptor selected for performing a landscape maintenance task; and a drive train for transferring torque generated by the rotating wheels to the drive axle. In the method, the wheels may be oversized. In the method, the wheels may be between about twenty-four inches and twenty-nine inches in diameter. In the method, the maintenance adaptor may include one or more of a reel mower, a reciprocating scythe, a rake, a twirling brush, a rotating feeder, a pump, a generator, a fan, a snow blower, an edger, a rotary blade mower, and a rotating brush.

In another aspect of the invention, a wheeled reel mower may comprise a frame for receiving an operating force from a user of the mower; two oversized wheels, each wheel rotating about an axle secured to the frame, the wheels independently rotating in response to the operating force, causing the mower to roll on the wheels along a surface; the frame supporting a spiral bladed reel mower and a fixed bed knife for cutting vegetation; and a drive train for transferring torque derived from the rotating oversized wheels to the spiral bladed reel, causing the spiral bladed reel to rotate past the fixed bed knife.

In another aspect of the invention, a wheeled sweeper may comprise a frame for receiving an operating force from a user of the sweeper; two oversized wheels, each wheel rotating about an axle secured to the frame, the wheels independently rotating in response to the operating force, causing the sweeper to roll on the wheels along a surface; a cylindrical brush for sweeping the surface; and a drive train for transferring torque derived from the rotating wheels to the cylindrical brush, causing the cylindrical brush to rapidly rotate, the brush positioned for pushing debris on the surface away from the sweeper.

In another aspect of the invention, a wheeled blower may comprise a frame for receiving an operating force from a user of the blower; two oversized wheels, each wheel rotating about an axle secured to the frame, the wheels independently rotating in response to the operating force, causing the system to roll on the wheels along a surface; a radial blade fan for dispersing material away from the blower; and a drive train for transferring torque derived from the rotating wheels to the radial blade fan, causing the fan to rapidly spin, the fan outlet positioned for blowing debris on the surface away from the sweeper.

In another aspect of the invention, a wheeled rotary mower may comprise a frame for receiving an operating force from a user of the mower; two oversized wheels, each wheel rotating about an axle secured to the frame, the wheels independently rotating in response to the operating force, causing the mower to roll on the wheels along a surface; the frame rotationally supporting a rotary mower blade for cutting vegetation; and a drive train for transferring torque derived from the rotating oversized wheels to the rotary blade, causing the rotary blade to rotate.

In another aspect of the invention, a wheeled edger may comprise a frame for receiving an operating force from a user of the edger; an oversized wheel, the wheel rotating about an axle secured to the frame, the wheel rotating in response to the operating force, causing the edger to roll on the wheel along a surface; the frame rotationally supporting an edge trimmer for cutting greens along a landscape edge related to the surface; and a drive train for transferring torque derived from the rotating oversized wheel to the edge trimmer, causing the edge trimmer to rapidly rotate.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a perspective view of an embodiment of the modular, human-powered landscape system of the invention.

FIG. 2 depicts a variety of maintenance adapters.

FIG. 3 depicts a graphical representation of energy transfer from the operator to a functional shaft of the landscaper.

FIG. 4 depicts a perspective view of an embodiment of the modular, human-powered landscape system of the invention.

FIG. 5 depicts a perspective view of an embodiment of the modular, human-powered landscape system of the invention.

### DETAILED DESCRIPTION

A modular landscaper may be operated by an operator. The operator may be responsible for providing forces required to operate the modular landscaper. Operating the modular landscaper may include gripping a handle and pushing or pulling the modular landscaper over a surface. An operator may include an adult, child, male, female, trained animal such as a dog, horse, mule, ox, and the like. The operation may be automated, such as may be provided by a robotic operator. The robotic operator may be fully automated, semi-automated, remote controlled, and the like. Power for the robotic operator may be solar based, fossil fuel based, biofuel based, and the like. In an example, an adult may be positioned behind the modular landscaper with one or two hands pushing the modular landscaper forward as the adult walks behind. The adult may control the direction of motion of the modular landscaper by applying a greater force near the left or right side of the modular landscaper, thereby causing the landscaper to turn opposite the force. The adult may also stop the modular landscaper by gripping the handle and standing still.

The modular landscaper may be operated by applying a force to the landscaper, such as a pushing or pulling force. A force may be applied to a fixed portion of the landscaper, such as a handle. The force may be applied directly to one or more of the wheels, although the handle is well suited for an operator pushing or pulling the landscaper. A force that is applied substantially horizontal or that may include a slight downward component, when directed in a substantially forward direction associated with the landscaper direction of wheel rotation may cause the landscaper to move forward. The forward movement may be enabled at least partially by oversized wheels making contact with the ground or other surface on which the landscaper is operating. In an example, a force applied to the handle is transferred through the frame to the axle. The axle pushes on the hubs of the wheels and in response, the wheels start to turn at least in part because friction between the wheels and the operating surface is greater than the resistance between the axle and the wheel hubs.

The force may be further used by the landscaper to operate a landscaping maintenance attachment. The turning wheels generate torque associated with the force. The torque generated is based on forward and downward components of the force and on the diameter of the wheels. The torque may be harnessed by a drive train and transferred through the drive train to a functional shaft or axle which may make contact with a rotating portion of the attachment.

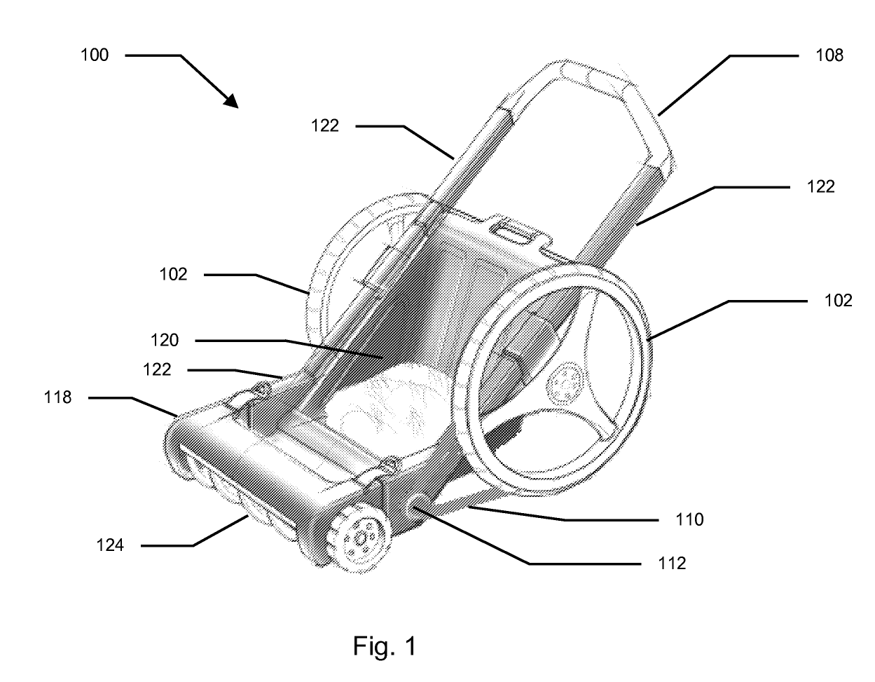

Referring to FIG. 1, a modular, human-powered landscaper 100 may include a frame 122 to which a handle 108 may be adjustably attached. The frame 122 may be supported by left and right wheels 102 that may be axially attached to the frame 122 so that the wheels 102 may turn when the handle 108 is pushed by an operator (not shown). A functional shaft 112 may also be axially attached to the frame 122 at a lower front portion of the frame 122. The landscaper 100 may further include a drive train 110 that may connect at least one of the wheels 102 to the functional shaft 112 and may enable the rotational motion of the wheels 102 to cause the functional shaft 112 to turn. In the embodiment of FIG. 1, the landscaper 100 may be configured with a reel mower maintenance attachment 118 and a storage bin 120 for receiving grass clippings from the reel mower attachment 118. The landscaper 100 may be operated by an operator pushing against the handle 108 generally in a direction that enables the wheels 102 to turn. Drive train 110 may begin moving as the wheels 102 turn, thereby transferring torque generated by the wheels 102 to the functional axle 112 causing the axle 112 to turn. Due to the large ratio established between the oversized wheels 102 and the functional axle 112, the functional axle 112 may turn rapidly. The reel mower maintenance attachment 118 may engage the functional shaft 112 so that spiraled blades 124 of the reel mower 118 turn past a fixed bed knife thereby cutting the grass. The speed of rotation of the spiraled blades 124 may be proportional to the speed of rotation of the functional shaft 112 and may be considerably faster than the rotational speed of the wheels 102 due to the transfer of torque from the wheels 102 through the drive train 110.

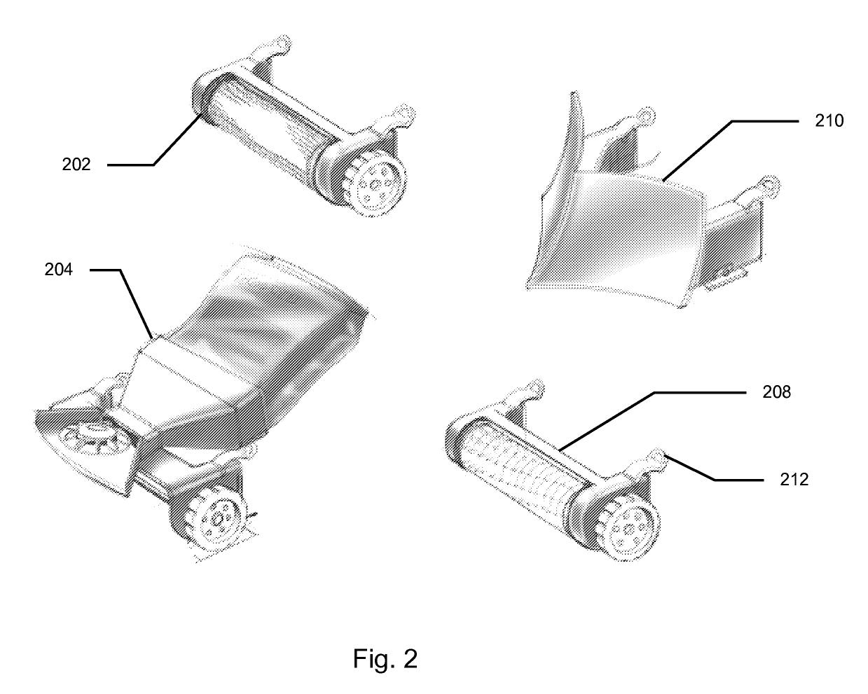

Referring to FIG. 2, the modular landscaper 100 may support a variety of interchangeable maintenance attachments to perform various landscaping functions. FIG. 2 includes a brush attachment 202, a dethatching or leaf raking attachment 208, a snow plow attachment 210, and a broadcast spreader attachment 204 shown with a feed bag and a dispenser. Each of the attachments that include moving parts may engage the functional shaft 112 from FIG. 1 so that the turning portion of the attachment turns in relationship to the functional shaft 112. Through the engagement of the functional shaft 112, the maintenance attachments convert the functional shaft 112 motion into a specific landscape maintenance function. The attachments may be attached to the landscaper frame 122 through bracket 212 herein depicted as a ring that may fit over a tab on the frame 122.

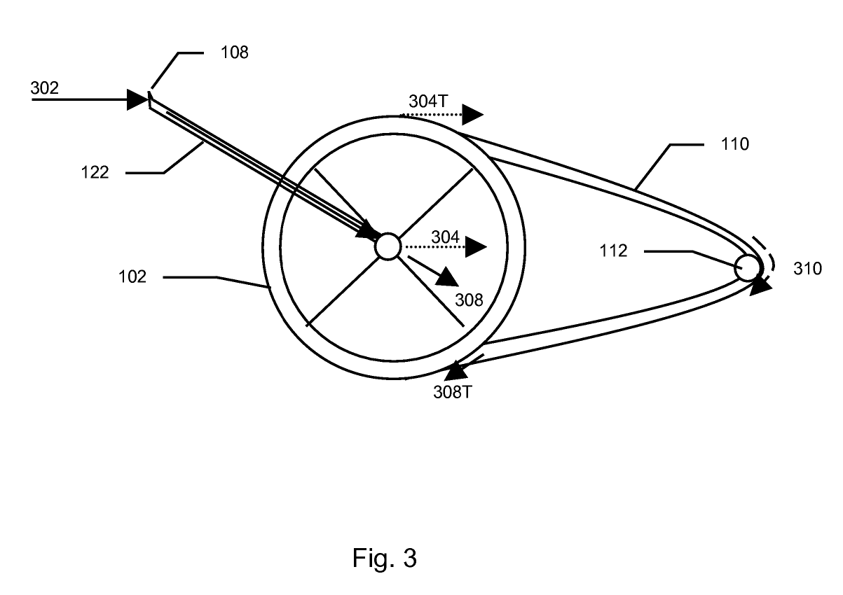

Referring to FIG. 3, the forces that operate the modular landscaper 100 are depicted in schematic form. An operator may provide a force 302 to the handle 108. The handle 108 and frame 122 may propagate the operator force 302 through to the axle of the wheel 102 wherein the wheel 102 reacts to the components of the propagated force 304, 308 by turning. The components of the propagated force 304, 308 cause torque components 304T and 308T to be generated as the wheel turns. The torque components 304T and 308T act on the drive train 110, forcing it to move along a path that includes the functional shaft 112. The torque components 304T and 308T combine in the drive train to provide rotational force 310 that may cause the functional shaft 112 to rotate.

Oversized wheels may provide solid grip on a variety of surfaces. Surfaces may include asphalt, concrete, cobblestone, pavers, flagstones, rough cut stone, brick, dirt, gravel, forest floor (e.g. decomposing leaves), grass, turf, and the like. Surfaces may include natural terrain such as crabgrass, bluegrass, fescue, field greens, weeds, seedlings, brush, and other natural surfaces. Natural surfaces may include one or more of short growth plants (e.g. turf), medium growth plants (e.g. crab grass, dandelions), and tall growth plants (e.g. weeds, seedlings, flowers). Surfaces may include man made turf, indoor/outdoor carpeting, plastic sealed concrete, wood (decking), patio, walkway, vinyl, composite decking, and the like. Surfaces may be dry, wet, damp, snow covered, ice covered, slushy, muddy, dusty, and other weather related conditions.

The wheels may include spokes, a hub, a rim, a tire, an inner tube, and other common tire elements and configurations. A tire, or outer portion of the wheel that makes contact with the operating surface, may include traction elements that increase frictional force between the wheel and the surface to allow greater forward force by the operator. Tires may include spikes, stubs, and the like that may increase surface gripping power and that may facilitate more efficient conversion of operator force into wheel torque. The wheels may comprise conventional bicycle wheels with air filled tires. The tires may be oversized (e.g. 26″ or 29″ diameter) to facilitate easy motion over smooth and rough terrain. The wheels may include air filled tires, or air filled inner tubes within the tires to deliver a moderate degree of shock absorption while maintaining excellent traction. The wheels may be made of lightweight metal, aluminum, graphite, composite materials, a polymer, and the like.

The wheels may be related to the functional shaft through a drive mechanism. The drive mechanism may transfer rotational energy (e.g. torque) from the oversized wheels. In an example, the drive mechanism may transfer torque from one of the oversized wheels to a functional shaft. In another example, the drive mechanism may transfer torque from both of the oversized wheels to a functional shaft, thereby providing a means of distributing the resistance to turning presented by the functional shaft to the two wheels. In another example, the axle may be fixed to the wheels so that the axle turns when the wheels turn and the frame may include a hub in which the axle turns. In this example, the drive mechanism may be positioned between the two drive wheels and may harness the rotational energy of the axle and deliver the harnessed rotational energy to a mid point on a rotational portion of the adapter. This example is similar to how some belt drive vacuum cleaners with rotating brushes operate.

The drive mechanism may include driving a plurality of functional axles. The plurality of functional axles may be driven by daisy chained drive mechanisms that transfer the rotational energy from the wheels to the first functional shaft and from the first functional shaft to a second functional shaft, and so forth. Other relationships between the wheels and the functional shaft(s) may include: one functional shaft driven by one oversized wheel and a second functional shaft driven by a second oversized wheel; two functional shafts driven by two drive trains from one oversized wheel; two functional shafts driven by one drive train from one oversized wheel; and other combinations that include one or more drive trains and one or more functional axles driven by one or more oversized wheels.

The drive mechanism, such as a drive train, may convert torque generated by the wheels into functional shaft rotating force. The drive train may include gears associated with the wheels and the functional shaft, with a joining chain or ribbed belt for transferring energy from the rotating wheels to the functional shaft. The drive train may be configured to convert the torque of the large wheels into high rotational speed of the functional axle.

The drive train may include a gear train that may include a large gear fixed to the rotating wheel turning a small gear fixed to the functional shaft. The gear train may include additional gears to increase the number of complete functional shaft rotations that result from a single rotation of the wheels. The gear train may also include gears between a gear fixed to the rotating wheels and a gear fixed to the functional shaft to adapt the functional shaft direction of rotation. In an example, a two gear gear-train will result in the functional shaft rotating in a direction opposite the direction of rotation of the wheels. By adding a third gear between the wheel gear and the functional shaft gear, the functional shaft will rotate in the same direction as the wheels.

The gears in the drive mechanism may include bevel gears, helical gears, spur gears, worm, worm gears, internal, miter, and any other type of gear including high friction, rubber, disk based, fluid filled, and the like.

The drive mechanism may convert the torque of the large wheels into high rotational speed of the functional shaft to deliver operating speeds of the maintenance attachment suited for cutting, mowing, brushing, scraping, spreading, raking, mulching, seeding, aerating, dethatching, and the like. Operating speed of the maintenance attachment may be based at least in part on the speed of rotation of the wheels which may be based in part on a forward or backward motion of the landscaper. However, due to transferring torque from the oversized wheels into rotational speed of the functional shaft, even a slow forward motion of the landscaper may result in the maintenance attachment turning sufficiently fast to perform landscaping tasks as herein disclosed.

The drive mechanism may include one or more pulleys, gears, cams, belts, chains, disks, shafts, and the like.

Torque generated by the wheels may be based on aspects of a force applied to move the landscaper and distance from the wheel center of rotation (e.g. the axle) to the point of torque production. Torque generated at the outer circumference of the wheel would be a function of the moving force and the radius of the wheels. Torque may be represented by a mathematical formula that includes the operator force and the wheel radius. An operator may be pushing the landscaper over level ground providing a forward pushing force that may be represented the symbol “F”. The landscaper wheels may have a radius represented by the symbol “R”. Therefore a simplified formula for the generated torque “T” may be:
T=R*F

Other factors such as wind resistance, friction between the axle and the wheel, and the like may be included in a more extensive calculation of the landscaper's torque generation capability. However, as can be seen, even in this simplified formula, the operator's pushing force is multiplied by the radius of the wheel resulting in an increase in force applied through the drive train to the functional shaft. The combination of oversized wheels and torque generation enable the landscaper to provide significant improvement in ease of operation, and reduction in operator exertion to complete the many common landscaping tasks herein disclosed.

The radial point on the wheel at which torque is generated may be a point between the wheel hub and the wheel outer diameter. In such a configuration, less of the operator force is converted into torque to turn the functional shaft. However the remainder of the operator force may more easily move the landscaper forward over the operating surface such as lawn. Design decisions as to where on the radius of the wheel to harness the torque generation may allow tradeoffs of ease of operation and rotational torque applied to the functional shaft. No matter what the relationship is between the size of the wheels and the radius point of torque pickup by the drive train, the oversized wheels facilitate operating the landscaper over nearly any type of terrain.

The modular landscaper may be constructed with a handle disposed between and behind the wheels, and located above the axle so that an operator pushing the landscaper with the handle may deliver a substantially forward pushing force that may be translated into a forward and downward force through the handle and frame. This handle position may provide an easy operator interface for pushing. The handle positions as described may also allow a small portion of the operator's pushing energy to be directed downward, such as to facilitate engaging the wheels with the operating surface (e.g. grass), while delivering a predominant portion of the operator's pushing energy into forward energy that results in torque generation. The handle may be at a fixed position relative to the wheels, or it may be operator adjustable. The handle adjustment may include vertical and horizontal adjustment, or a combined adjustment that affects both horizontal and vertical position. In an example, an operator who is 5′2″ tall may adjust the handle down and move it closer to the axle to allow easier operation of pushing and control. In another example, an operator who is 6′5″ tall may adjust the handle up and further away from the axle so that the operator can stand comfortably and walk with a natural gate. In an alternate configuration, the wheels may be independently attached to an open frame that allows an operator to position any portion of his/her body between the wheels. This may provide an advantage in that the operator may be able to control the direction of the landscaper better because the distance from the landscaper center of rotation to the operator could be significantly reduced.

The handle or other user gripping interface may include various controls for features of the landscaper. Features such as an integrated work light, an operator fan, alternative power delivery sources, and the like may be available, therefore controls for the features may be disposed on or near the handle for easy operator assess and use of the features.

The modular landscaper may be associated with alternate power sources. As a supplement to, or instead of human/operator power, the landscaper may include one or motors to facilitate turning the wheels, generating torque, turning the functional shaft, activating the maintenance attachment, an the like. Power for the one or more motors may be derived from renewable energy, such as solar power. The landscaper may include solar collector panels positioned to collect sunlight when the landscaper is in a normal wheels-down stance. Alternatively, the solar collectors may be detached or detachable from the landscaper so that they can be removed when the landscaper is being operated. In any of the above solar powered configurations, the motor may be directly powered by a rechargeable battery that is recharged through the solar collectors. The rechargeable battery may alternatively be charged through a conventional electric source such as a household AC line. Additionally, one or more electric motors may be directly powered by household AC line through use of an extension cord from the household AC line to the landscaper.

Another alternate energy source for powering motors that may be associated with the landscaper is biofuel. An internal combustion engine adapted to use biofuel may provide clean, energy efficient operation of portions of the landscaper.

Another alternative energy source for supplementing operator power may include a spring that may be tensioned through movement of the landscaper. An operator of the landscaper may choose when to engage the spring to store energy or use energy in the spring. By allowing the operator to selectively engage the spring, potential energy may be stored in the spring when the operator determines potential energy is available, such as when walking the landscaper from a storage area to an operating area (e.g. from a garage over a driveway to a lawn), or when operating the landscaper down a hillside. The operator may also selectively engage the spring to use the potential energy stored in the spring to provide additional operating force for the landscaper (such as when the landscaper is being operated up a hill or when the task presents a user determined amount of resistance (e.g. when using the snow blower adapter in wet snowy conditions). The spring force may be applied to the wheels, to the functional shaft or both. Energy may be supplied to the spring with either forward or backward motion of the landscaper.

The modular landscaper may include a container. The container may be configured to enable debris pickup and carrying, distribution of seed or other spreading substances, and the like. The landscaper may include a plurality of containers, such as one container for grass seed and one for grass fertilizer. Each container of the plurality of containers may be used for different purposes. A container included with the landscaper may be a multipurpose container that could be used with any of the landscaping tasks herein described. The container may also provide storage for materials or equipment that may be required to complete a landscaping task. In an example, the container may hold various vegetation cutting tools, such as hedge shears so that the operator may have ready access to the hedge shears as needed. The container may further increase the efficiency of landscaping tasks by enabling an operator to perform a manual task, such as trimming a hedge that is far away from the hedge shears storage location, when the operator uses the landscaper near the hedge—such as to cut the lawn near the hedge. By saving the operator the time of separately retrieving the hedge trimmers, and saving energy associated with a separate trip to retrieve the shears, the modular landscaper provides additional benefits to landscaper users and owners.

The container may be permanently attached to the landscaper. Alternatively the container may be removably attached so that the operator can attach, remove, and reattach containers. In an example, an operator may remove a grass catching container in favor of a fertilizer dispensing container between the tasks of cutting a lawn and feeding a lawn. The container or containers may be attached to the landscaper frame through a variety of attachments including: a nut and bolt, a screw, a nail, a rivet, a magnet, an adhesive, a hook-and-loop, an interference locking system, a threaded connection, a sliding attachment, a hinge, a clamp, a tab, a spring-loaded attachment, a sleeve attachment, a snap-fit connection, a ball closure, discrete interlocks, a clasp, a clip, a zipper, a snap, a gasket, an O-ring type closure, a hook-and-eye, a spring-locking hinge, and the like.

The container may include one or more of a bag, a bucket, a bin, a sleeve, a tarp, a box, a holder, a hopper, a repository, a vessel, a tub, a vat, a plastic sheet, and the like. The container may be recyclable, disposable, flexible, rigid, lockable, and the like. The container may be made of a wide variety of materials including plastic, metal, cloth, paper, composite, mesh, and the like. The container may be used for collecting grass, leaves, vegetation, debris, snow, dirt, twigs, bugs, and the like. The container may be adapted to provide storage and delivery of materials to be dispersed by a maintenance attachment (e.g. a grass seed or fertilizer spreader). The container may have a user adjustable opening to control dispensing to the spreading portion of the maintenance attachment. The container may include an opening that may be at least partially automatically controlled based on the forward speed of the landscaper. The container may include an open top so that the operator can see the amount of material (for spreading or being collected) that is in the container from a natural walking & operating position. The container may alternatively include a content viewing portal. The container may be at least partially constructed of translucent material to allow an operator to view the contents of the container. The container may include graduation markings representing units of measure. The container, while variously described herein and enabling various capabilities, may be any type of container suitable for use with a modular landscaper. All embodiments of a container are herein included.

The modular landscaper may include a tool rack or shelf for holding tools, such as landscaping tools. These tools may include tools such as shears, brushes, clippers, cultivators, hammers, axes, gloves, goggles, ear protection, face masks, knives, shovels, weeders, and the like. The tool rack may be adapted so that specific function tools are provided conforming supports. In an example, the tool rack may include a holder adapted to support an axe or a hammer, a separate holder to support shears, and a hook for hanging gloves, goggles and the like.

The landscaper may include storage racks for one or more landscape maintenance attachments. An attachment storage rack may allow an operator to transport one or more landscape maintenance attachments while performing maintenance functions. In an example, the operator may select a grass cutting attachment to be operably attached to the landscaper and a sweeping attachment to be transported. In the example, the operator may switch from the grass cutting attachment to the sweeping attachment to clean up grass clippings from a sidewalk or driveway without having to return to a storage area to retrieve the sweeping attachment. Landscaping tasks that are commonly done in sequence or are necessary to complete a maintenance operation include cutting and edge trimming, cutting and sweeping, raking and blowing, seeding and fertilizing, dethatching and seeding, aerating and seeding, cutting and blowing, and many other combinations. By providing maintenance attachment storage, the modular landscaper further saves time and effort associated with many common landscape maintenance jobs.

The modular landscaper may include a structural frame. The structural frame may support a handle, a tool rack, an attachment storage rack, an axle, the wheels, the functional shaft, maintenance attachment features, container attachment features, and the like. The frame may be constructed of a variety of lightweight materials suitable for outdoor use. Materials for the frame may include aluminum, plastic, steel, carbon fiber, composite materials, combinations of these materials, and the like. Portions of the frame, such as a portion for supporting the wheels, may be constructed of a material suitable for supporting forces associated with the function of transferring an operator pushing energy into rotational energy. Other portions, such as a tool rack, may be made of lightweight plastic that is sufficient for the purpose.

The frame may include features that enhance an operator experience while performing a landscape maintenance task. The experience enhancing features may include an umbrella stand for supporting a lightweight umbrella to shade an operator from the sun, a cup holder for holding a refreshing drink, an entertainment device holder for supporting a digital music player or radio, a cell phone holder, and the like. An operator experience may be enhanced through the use of an entertainment device such as an MP3 player or a cell phone because the landscaper produces relatively small amounts of operating noise.

Landscaping tasks may be accomplished through landscape maintenance attachments. Landscape maintenance attachments may be modularly attachable to the landscaper so that one or more landscape maintenance attachments may be attached and enabled. The landscaper may include a variety of features that facilitate attaching maintenance attachments that are designed to perform different landscaping maintenance tasks. Landscaping maintenance attachments may be attached to the landscaper frame through a nut and bolt, a screw, a nail, a rivet, a magnet, an adhesive, a hook-and-loop, an interference locking system, a threaded connection, a sliding attachment, a hinge, a clamp, a tab, a spring-loaded attachment, a sleeve attachment, a snap-fit connection, a ball closure, discrete interlocks, a clasp, a clip, a zipper, a snap, a gasket, an O-ring type closure, a hook-and-eye, a spring-locking hinge, and the like.

The landscape maintenance attachments may enable landscaping tasks including edging, cutting, mowing, sweeping, blowing, raking, cleaning, painting, lifting, mulching, spreading, brushing, dispensing, aerating, dethatching, composting, trimming, electricity generation, vacuuming, debris collecting, spraying, and the like. These and other landscape maintenance tasks may be performed by attachments configured to take advantage of the landscaper torque generation functionality.

The modular landscaper may be associated with mowing vegetation. Mowing vegetation may be accomplished through a maintenance attachment suited for a mowing function. This may include a reel mower attachment, a rotating blade attachment, an oscillating scythe attachment, a shearing attachment, and the like. A reel mower attachment may include spiraled blades equally spaced around a reel shaft that is generally elongated and defines a rotation axis extending along the length of reel shaft. The reel shaft may be attached to the landscaper functional shaft so that rotation of the functional shaft results in rotation of the reel shaft and the spiraled blades. The attachment may include a conventional fixed bed knife disposed so that the blades orbit relative to the shaft and move past the fixed bed knife for the usual and well-known function of cutting vegetation. The reel mower attachment may be preassembled with attaching features adapted to readily interface to mating attaching features on the landscaper.

A rotating blade maintenance attachment may include a rotation converter that receives the functional shaft and converts it from a horizontal rotational axis into a vertical rotational axis. The converter may be a pair of shafted gears producing a ninety degree change in the rotational axis. The shafted gears may include a gear ratio that increases the rotational speed of the vertically aligned axis, thereby causing the blades attached to the vertical shaft to rotate faster than the functional axis rotates. The rotating blade maintenance attachment may enable the torque generated by the drive wheels to be transferred to the blade so that the blade rotational speed is related to the landscaper speed. The rotating blade maintenance attachment may include a single rotating blade, or may include a plurality of rotating blades. The plurality of rotating blades may require less torque to achieve a sufficiently high rotational speed for mowing. The plurality of rotating blades may include at least three blades so that they may be relatively positioned to form vertices of a triangle. This configuration may ensure that all vegetation passing within the furthest reach of the two outboard rotating blades will contact at least one of the cutting blades.

An oscillating scythe or sickle maintenance attachment may provide coarse cutting at heights greater than a rotary or reel mower attachment may reach. The oscillating scythe maintenance attachment may include a drive mechanism that converts the functional shaft rotation into an oscillating motion similar to an automobile windshield wiper blade. The cutting edges of the scythe may move in a horizontal plane, or at an angle to horizontal so that a leading edge of the scythe is elevated above the oscillation point.

A shear cutting maintenance attachment may include shears that operate in a scissoring motion. The attachment may include a plurality of shears. The plurality of shears may be positioned at various heights and at various offsets so that vegetation is cut cleanly and thoroughly. The shear cutting maintenance attachment may include a drive train that converts the functional shaft rotation into scissor type cutting motion. This may include oscillating cutting knives that pass over each other similar to a scissor or automatic hedge trimmer. Alternatively, the shear cutting maintenance attachment may include a fixed blade or set of blades and a moving set of blades. The moving set of blades may be attached to a belt or chain that is moved along a path between and around two sprockets in response to the functional shaft rotation. Various other types of shearing action may be included such as two sets of moving blades, more than two sets of moving blades, multiple banks of blade sets to allow a first and second cutting with one pass of the landscaper, and the like. Shear cutting maintenance tasks may be performed horizontally, or vertically, or at some other angle between horizontal and vertical. The attachment may facilitate cutting vertical growth such as a vine growing on a wall or trimming back vegetation overhanging a path.

Mowing and cutting tasks may be combined with debris collection. The landscaper may include a hopper positioned so that the debris cut by the mowing attachment may be conveniently collected and transported on the landscaper for later disposal. The hopper may be associated with the attachment, with the landscaper, or both.

The modular landscaper may be associated with lawn edging. Lawn edging may be accomplished through a maintenance adaptor suited for an edging function. In an example, an edging function may be performed by an edge trimmer maintenance attachment. Lawn edge trimming is commonly performed as part of a complete lawn maintenance job. The landscaper may facilitate performing this task through the use of an edge trimming attachment that takes advantage of the landscaper's torque generating capability. Lawn edge trimming is conventionally performed by moving an edge trimmer along the edge to be trimmed. The landscaper may readily be moved along an edge of a lawn, such as on the lawn or on the surface defining the edge. An edge trimming maintenance attachment may include a rotating cutting implement, such as a flexible plastic line or a rotating blade that creates a substantially vertical cut. The horizontal axis of rotation of the functional axle may provide a straightforward means of rotating the lawn edging attachment.

The modular landscaper may further be adapted to be partially disassembled so that at least a portion of the handle, frame, one drive wheel, and the drive train can be operated as a separate unit, such as for lawn edge trimming. An edge trimming attachment may attach to the single wheeled unit so that the torque generated by the wheel is delivered to the attachment through the drive train. A single wheeled configuration of the landscaper, as described above or as a dedicated apparatus, may facilitate lawn edge trimming along curved edges or in narrow places, such as along garden beds and the like.

Landscaping maintenance tasks such as snow removal may be facilitated by the landscaper through one or more snow maintenance attachments. Snow maintenance attachments may include a snow broom, a snow blower, a snow plow, a snow scoop, an ice melt dispenser, and the like. A snow broom, snow brush, snow sweeper, and the like may be useful in removing small accumulations of light or dry snow from surfaces. A snow broom maintenance attachment may include a rotating brush attachment, an oscillating brush attachment, a combination of the two, and the like. The rotating snow brush may receive the rotating functional shaft and directly transfer that rotation to a shaft that engages the rotating brush. The rotating brush may be a cylindrical brush. The rotating brush may be positioned so the axis of rotation is perpendicular to the direction of motion of the landscaper, causing the snow to be pushed ahead and in the direction of motion of the landscaper. Alternatively, the brush axis of rotation may be at a slight angle relative to the landscaper direction of movement so that the snow is pushed away from the landscaper direction of motion. The snow broom attachment may include an oscillating broom apparatus that may include a broom performing a side to side sweeping motion in response to the functional shaft rotation.

Snow maintenance may be accomplished by a snow blower attachment. A snow blower attachment may include an impeller driven by the functional shaft to force air through a channel so that the air causes the snow near an opening in the channel to be blown away from the channel opening. The impeller, such as rotary fan, an axial fan, or a radial fan, may be driven by the functional shaft. The channel direction may be operator controllable so that the operator may select a direction of snow blowing.

Snow maintenance may also be accomplished by a snow thrower attachment. A snow thrower attachment may include a primary mechanism that includes spiraled blades similar to a reel mower but adapted for snow pickup. The spiral blades may be driven by the functional shaft and the blades may push snow into a hopper. The snow thrower maintenance adaptor may include a second snow throwing stage that may also be driven by the functional shaft, or may include a second functional shaft that may be driven by the landscaper drive train. The second snow throwing stage may include an impeller that forces the snow through a shoot away from the landscaper. The impeller may be driven by a drive train associated with the attachment that is daisy chained from the primary mechanism drive shaft.

The snow maintenance attachment may include a snow plow that may force show laterally while the landscaper is pushed forward.

The landscaper may be configured with a debris maintenance attachment. The debris maintenance attachment may include a rake, a brush, a broom, a blower, and the like. A debris broom, brush, sweeper, and the like may be useful in removing debris from smooth surfaces (e.g. walkways, driveways, and the like). A debris broom maintenance attachment may include a rotating brush attachment, an oscillating brush attachment, a combination of the two, and the like. The rotating debris brush may receive the rotating functional shaft and directly transfer that rotation into brush rotation. The rotating brush may be a cylindrical brush. The rotating brush may be positioned so the axis of rotation is perpendicular to the direction of motion of the landscaper, causing the debris to be pushed ahead of the landscaper in the direction of motion of the landscaper. Alternatively, the brush axis of rotation may be at a slight angle relative to the landscaper direction of movement so that the debris is pushed away from the landscaper. The debris broom attachment may include an oscillating broom apparatus that may include a broom performing a side to side sweeping motion in response to the functional shaft rotation.

Debris maintenance may be accomplished by a debris blower attachment. A debris blower attachment may include an impeller driven by the functional shaft to force air through a channel so that the air causes the debris near an opening in the channel to be blown away from the channel opening. The impeller, such as rotary fan, an axial fan, or a radial fan, may be driven by the functional shaft. The channel direction may be operator controllable so that the operator may select a direction of debris discharge.

Debris maintenance may be accomplished by a debris rake attachment. Debris such as grass clipping, fallen leaves, vegetation clippings and the like may be removed through raking. The debris rake maintenance attachment may provide efficient raking action through a rotating rake attachment. The rake attachment may be driven by the rotating functional shaft through ratio adjustment gears that reduce the speed of the rake motion relative to the functional shaft. The functional shaft may be turning at a high rate of rotation due to the transfer of torque from the landscaper wheels to the functional shaft through the landscaper drive train. A ratio adjustment may allow the rotating rake to turn at speed that is suitable for raking, while providing enough power to the rotating rake to ensure it rakes up an acceptable amount of debris. The rotating rake may include a rotating cylinder to which rake tines are radially attached so that the tines interact with debris on the operating surface with the objective of collecting the debris through a raking action.

Debris maintenance may be combined with debris collection. The landscaper may support a hopper or container into which debris that is swept, brushed, blown, or raked may be deposited.

The modular landscaper may be configured with a cleaning attachment for cleaning operating surfaces. The cleaning attachment may include reservoirs for water, detergent, and other liquids. The cleaning attachment may also include dry reservoirs for powered or granulated cleaners, buffers, polishes, and the like. The cleaning and rinsing materials in the reservoirs may be dispensed while the landscaper is being operated. The cleaning attachment may include operator controls, such as mechanical levers, to adjust a rate of dispensing of the materials in the reservoirs. Alternatively, the rate of dispensing may be partially determined based on the speed of forward motion of the landscaper. Scrubbing brushes, polishing disks and the like may be configured as part of the cleaning attachment. These brushes and polishing disks may be operated through a rotation adaptor that uses the functional shaft rotation to drive the brushes and/or disks. The cleaning attachment may be used on a variety of surfaces, such as driveways, walk ways, patios, decks, pools, landings, sidewalks, roads, garage floors, basement floors, lobbies, and the like. By combining the torque generating power of the landscaper to drive heavy duty scrubbing brushes with controlled dispensing of cleaning materials from reservoirs, the landscaper configured with the cleaning attachment may facilitate cleaning surfaces such as outdoor or indoor surfaces. In an example, an operator may configure the landscaper with the cleaning attachment and fill one or more of the reservoirs with water and another reservoir with detergent. The operator may then position the landscaper on an operating surface to be cleaned, adjust the dispensing rate of the water and the detergent, and push the configured landscaper over the surface to be cleaned. The forward motion of the landscaper will generate torque that will be transferred through the drive train to cause the functional shaft to rotate. The cleaning attachment will convert the rotation of the functional shaft into a scrubbing or polishing action to enable cleaning the operating surface.

The torque generated by the modular landscaper may be used to generate electric energy. The electric energy generated may be stored in a battery or used to power a device associated with the landscaper. Electric energy may be generated by a generator attachment. A generator attachment may include an electromagnetic induction type generator that uses the rotating functional shaft to turn the inductor wire. The generator may power a motor to provide additional torque or to supplement the force applied by the operator by turning the wheels. The generator attachment may alternatively be used to power a work light, power an operator cooling fan, and the like. Electricity from the generator attachment may be used to provide power to speakers mounted on the landscaper to facilitate an operator listening to music from a digital music player.

The generator attachment may generate static electricity, such as to power a work light. A work light, such as a light emitting diode, may receive power directly from the static electricity generator. The work light may illuminate a portion of the operating surface in front of the landscaper to facilitate an operator viewing the illuminated surface.

A pump attachment may be configured with the landscaper. The pump attachment may use the turning action of the functional shaft to turn a pump. The pump attachment may include or interface to a pump reservoir that may provide liquid to be pumped by the pump. A pump attachment may be used to dispense or disperse liquid fertilizer, pesticide, detergent, water, paint (e.g. for parking lot striping), and the like. A pump attachment may be combined with a cleaning attachment. The pump attachment may be used with the cleaning attachment to dispense cleaning liquids, or deliver pressurized cleaning liquids (e.g. water) to the operating surface to enhance the cleaning function.

The landscaper may be configured with a broadcast spreader attachment. The broadcast spreader attachment may be adapted to disperse materials such as pellets, particulates, granules, seed, fertilizer, weed control, moss control, lime, and the like. The broadcast spreader attachment may include a disperser that rotates around a vertical shaft that is driven by the functional shaft. The disperser may be a horizontal rotating plate that applies centrifugal forces to substances dispensed on the plate. The broadcast spreader attachment may include a spreading guide that facilitates spreading the substance (seed, fertilizer, etc) away from the landscaper. The broadcast spreader attachment may include, or may interface with a bin or hopper that may contain and dispense the substance to be broadcast. The broadcast spreader attachment may be combined with a bin or hopper separately assembled to the landscaper for holding and/or dispensing substances to be broadcast.

The landscaper may be configured with a mulching attachment. The mulching attachment may grind and/or shred clippings and other vegetation so that the mulched material may be spread over an operating surface such as a lawn or garden. The clippings and/or vegetation may be collected by a collection facility of the landscaper. The collection facility may receive clippings from the mower attachment, the shear cutting attachment, the debris maintenance attachment, or from the operator. When combined with another attachment, such as the mowing attachment, the landscaper may provide complete cutting and mulching functions that are commonly performed by engine powered rotary mowers. However, the modular landscaper may perform these functions easily through human-powered operation and the torque conversion drive train.

A rotary trimmer, such as a line trimmer, may be adapted into a trimming attachment for the landscaper. A rotary trimmer is conventionally used to trim lawns around vertical surfaces protruding or growing out of the lawn (e.g. a tree, fence, wall, and the like.) A rotary trimmer attachment may function similarly to a rotary cleaning brush attachment described herein. Alternatively, the rotary trimmer may be driven through a flexible belt that transfers the rotational energy of the functional shaft to rotate the trimmer. A trimming attachment may be configured so that the trimmer operates substantially at the front of the landscaper, or it may be configured so that the trimmer operates along a side of the landscaper.

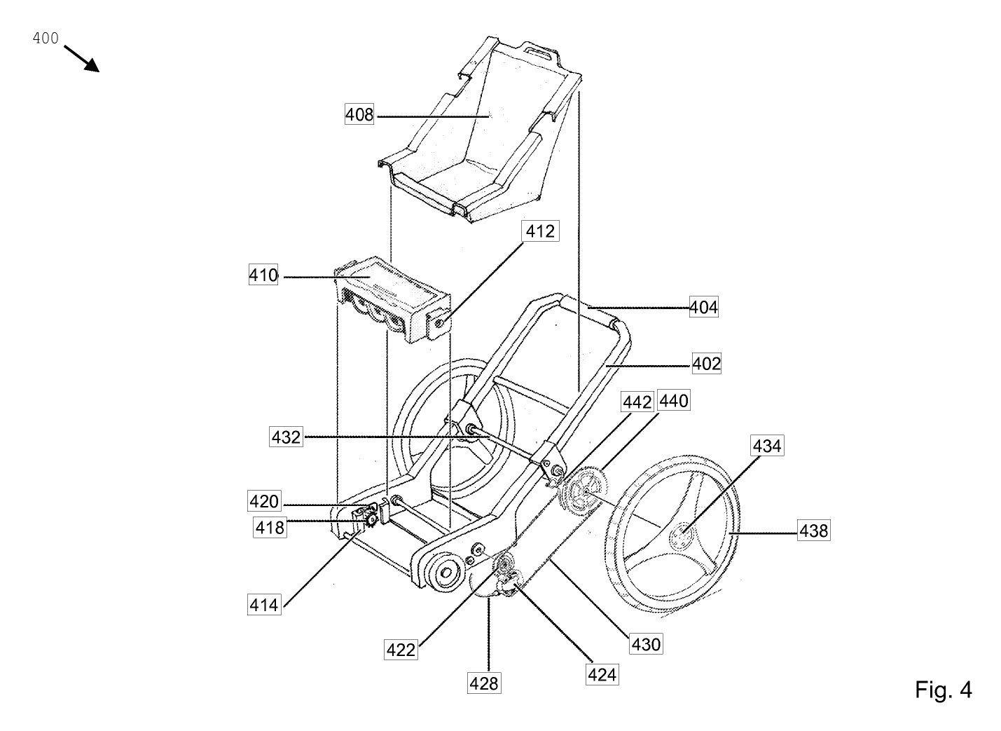

Referring to FIG. 4, the modular landscaper 400 may support a variety of interchangeable maintenance attachments to perform various landscaping functions. FIG. 4 includes a tube frame or composite chassis 402, a grip area for pushing 404, a hopper 408, a reel mower 410, a drive connection to attachment with gearing as appropriate 412, mechanism for coupling of attachment 414, drive cog 418 for engagement of with gear of attachment coupling, gearing for speed selection of attachment drive 420, gear cluster 422 at front drive takeoff, derailleur to change gears with selector at grip via coaxial cable 424, coaxial cable for gear selection 428, a chain drive 430, a connecting drive axle 432 which lets either wheel drive to chain-wheel and chain, a freewheel 434 at hub of drive wheel provides continuous power from either wheel when turning, drive wheel 438, chainwheels 440 which attach to wheel transmit torque via chain to front sprockets, derailleur to change gears with selector at grip area via coaxial cable 442, and the like. The hopper 408 may be a collection hopper and may hold cut grass, swept debris, and the like. The hopper 408 may be a supply hopper for seed, fertilizer, and the like. The hopper 408 may hold anything associated with the function of the modular attachment. While the reel mower 410 is depicted, it is understood that any modular attachment may be used with the modular landscaper 400.

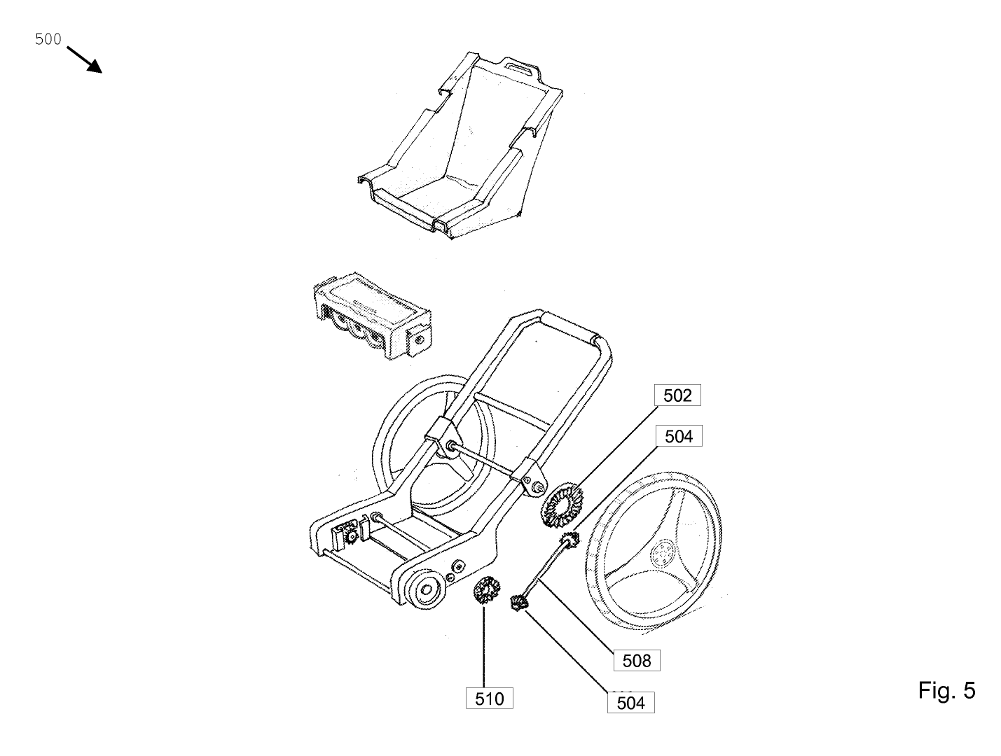

Referring to FIG. 5, the modular landscaper 500 may support a variety of interchangeable maintenance attachments to perform various landscaping functions. FIG. 5 includes a ring bevel gear connected to the axle 502 and driven by either or both wheels through freewheel, a bevel gear 504 on either end of a driveshaft 508, a ring bevel gear or standard bevel gear drive to gearbox for attachment 510, and the like. While the reel mower is depicted, it is understood that any modular attachment may be used with the modular landscaper 500.

The modularity of the landscaper and the maintenance attachments facilitate offering various combinations of attachments and the landscaper for sale. Each maintenance attachment may be offered for sale separately from the landscaper. The landscaper may be offered for sale with a predetermined attachment, or set of attachments. In an example, the landscaper may be offered for sale with a reel mowing attachment and a debris maintenance attachment (e.g. leaf blower) as a starter package. Various combinations of the attachments may be offered for sale as kits. Kits may include related attachments. Examples of kits with related attachments may include: snow broom and blower; leave rake, collector, and hopper; mower and collector; spreader, dethatcher, and aerator; cleaner attachment, detergent supply, water hopper/dispenser; and the like. Offering the maintenance attachments individually or in kits may allow a user to select and purchase attachments as needed or desired, thereby tying a portion of the cost of ownership to the number of different attachment purchased.

The landscaper may be modularly constructed to allow for easy disassembly, such as partial disassembly to reduce the volume of the landscaper, to facilitate storage, portage, and the like. A modular design may be less costly to manufacture since common parts may be constructed in high volumes. A modular design may reduce a total amount of storage space needed for the diverse landscaping tasks, when compared to dedicated manual or engine powered equipment. With no motors to maintain, the modular landscaper requires little preventive maintenance and easy repair. A modular design also facilitates future expansion of supported capabilities as new technologies or techniques enable the availability of different or enhanced attachments. The attachments, and the modular portions of the landscaper may be readily attached through a variety of attachment means including a nut and bolt, a screw, a nail, a rivet, a magnet, an adhesive, a hook-and-loop, an interference locking system, a threaded connection, a sliding attachment, a hinge, a clamp, a tab, a spring-loaded attachment, a sleeve attachment, a snap-fit connection, a ball closure, discrete interlocks, a clasp, a clip, a zipper, a snap, a gasket, an O-ring type closure, a hook-and-eye, a spring-locking hinge, and the like. A modular design may also reduce producer and retailer warehousing and inventory requirements while offering customers a wide variety of landscape maintenance options.

A human-powered modular landscaper may provide benefits associated with safety. With no engine, there are no dangerous energy sources to deal with. No gasoline containers, storage, pouring, transporting of full fuel containers in vehicles, and the like. Electric cords or high voltages to power electric motors are not needed. Human-power also produces no carbon based pollution, making the modular landscaper environmentally safe and friendly. Because a human-powered modular landscaper has no engine noise, noise stress is significantly lower than that imposed by a gasoline powered engine. The modular landscaper also offers an opportunity for an operator to get some exercise while performing many regular landscaping tasks, rather than having to drive to an exercise facility, such as a health club. A human-powered landscaper may be safe to operate near pets, children, small animals, and the like since the power generated is from the operator. However, the modular landscaper provides flexibility so that an alternate source of power, such as a backup electric motor may be configured to be used with the landscaper. Human-power may also facilitate controlling the landscaper to avoid damaging the operating surface.

The landscaper, through the modular attachments being enabled by the torque generating and harvesting drive train may perform a wide variety of landscape maintenance tasks, including: cutting, sweeping, blowing, raking, cleaning, painting, lifting, mulching, spreading, brushing, polishing, dispensing, edging, generating electricity, and the like.

The modular landscaper may be operated on a wide variety of surfaces. Some outdoor surfaces on which the landscaper may be operated include: natural terrain such as crabgrass, bluegrass, fescue, field greens, weeds, seedlings, brush, and other natural surfaces. Natural surfaces may include one or more of short growth plants (e.g. turf), medium growth plants (e.g. crab grass, dandelions), and tall growth plants (e.g. weeds, seedlings, flowers). Surfaces may include man made turf, indoor/outdoor carpeting, plastic sealed concrete, wood (decking), patio, walkway, vinyl, composite decking, and the like. Surfaces may be dry, wet, damp, snow covered, ice covered, slushy, muddy, dusty, and other weather related conditions.

A modular landscaper may be associated with markets, such as home markets, commercial markets, healthy living markets, alternative energy markets, and the like. The home market may include urban setting, suburban locations, and even rural home markets. Condominium or community-living home markets may be good candidate markets for commercializing the modular landscaper because landscape requirements, such as lawns, tend to be less demanding than large rural locations. Municipalities or homeowners associations may impose limits on hours of operation of noisy landscaping equipment, thereby restricting the home owner to these limited days and/or times. The human-powered modular landscaper may be operated outside of any limits associated with loud landscaping equipment, thereby providing the operator with schedule flexibility to landscape at the operator's convenience. Homes with lot sizes greater than 5000 square feet may benefit from the landscaper's novel torque generating design so that the homeowner may readily perform landscape maintenance tasks throughout the acre parcel using the landscaper and appropriate maintenance attachments. The landscaper may also be beneficially applied in home markets where fuel is hard to get or expensive to buy.

Commercial markets may take advantage of the modular landscaper to save fuel costs, reduce time and cost associated with engine maintenance, save costs and time associated with disposing of hazardous materials such as engine oil, and the like. Commercial markets where labor costs are low may also benefit from the modular landscaper's ability to decrease operator fatigue and time to perform many landscaping tasks. Rather than hassling with the complexities of gasoline powered equipment that must still be operated by manual labor, the human-powered modular landscaper may facilitate an improvement on profit.

A human-powered modular landscaper may be promoted as a beneficial part of a healthy lifestyle. Providing a combination of moderate self-paced exercise with low risk outdoor activity, the landscaper may offer operators the opportunity to comply with general medical guidelines and recommendations for exercise, such as walking, which is generally acknowledged as an excellent form of exercise.

Alternative energy groups, especially groups involved in initiatives to reduce the use of fossil fuels may endorse the modular landscaper because it enables human-powered landscaping to be readily and effectively applied to lawns larger than the largest lawn that is conventionally associated with a manual reel type mower. Combining the use of oversized wheels for operating stability and ease of rolling with torque generation by the oversized wheels, may enable the modular landscaper to be used instead of any type of landscaping equipment designed to address landscape maintenance tasks associated with an operating surface such as the ground.

The modular landscaper and the various maintenance attachments may be appealing to retailers and commercial providers servicing existing traditional landscape equipment markets. Because of the landscaper's advantages over conventional human-powered mowers, edgers, sweepers, and the like, the landscaper may appeal to retailers who offer for sale these conventional human-powered landscape systems. Gasoline and electric powered mower and landscape equipment makers may desire to include the landscaper in their landscape equipment offerings due to it's advantages in reduction in maintenance, modularity and low cost of ownership, availability and interchangeability of maintenance attachments, and the like. Lawn care product makers may find that joint or associated marketing of their products, especially natural lawn care products, with retailers of the modular landscaper may provide opportunities to build market share and promote their objectives of environmentally safer lawn and landscape care.

1. A method of landscape maintenance, comprising:
axially attaching a plurality of wheels to a frame, the wheels rotating and generating torque upon movement of the frame;
providing a functional shaft axially attached to the frame;
delivering the generated torque to the functional shaft, thereby causing the functional shaft to rotate; and
using the rotation of the functional shaft to enable a landscape maintenance function.

2-3. (canceled)

4. The method of claim 1, wherein the frame is configured to allow a walking operator to push the frame.

5-18. (canceled)

19. The method of claim 1, wherein the functional shaft engages a maintenance attachment, and wherein at least a portion of the maintenance attachment operates in response to the rotating functional shaft.

20-56. (canceled)

57. The method of claim 1, further including a receptacle supported by the frame for receiving debris from the maintenance function.

58-60. (canceled)

61. A modular landscape maintenance system, comprising:
a frame for receiving an operating force;
two wheels rotating about an axle secured to the frame, the wheels rotating in unison in response to the operating force, causing the system to roll on the wheels along a surface;
a drive axle for activating a maintenance adaptor that is attached to the frame, the maintenance adaptor selected for performing a landscape maintenance task; and
a drive train for transferring torque generated by the rotating wheels to the drive axle.

62-69. (canceled)

70. The method of claim 1, wherein delivering the generated torque comprises providing a drive train between a rotating portion of the wheels and the functional shaft.

71. The method of claim 70, wherein the drive train operates in response to the rotation of the wheels and the functional shaft rotates in response to the operation of the drive

72. The method of claim 1, wherein the maintenance adaptor comprises at least one of a reel mower, a reciprocating scythe, a rake, a twirling brush, a rotating feeder, a pump, a generator, a fan, a snow blower, an edger, a rotary blade mower, and a rotating brush.

73. The method of claim 72, wherein the cutting height of the reel mower is adjustable.

74. The method of claim 72, wherein the reciprocating scythe comprises a plurality of blades.

75. The method of claim 72, wherein the rotating feeder comprises a distribution plate.

76. The method of claim 72, wherein the snow thrower comprises a first stage snow collector and a second stage snow expeller.

77. The method of claim 72, wherein the pump is a liquid feed pump.

78. The method of claim 72, wherein the generator converts the rotation of the functional shaft into electricity

79. The method of claim 1, wherein the wheels have a diameter of between about twelve inches and about thirty inches.

80. The method of claim 1, further including a second functional shaft axially attached to the frame, the second functional shaft being rotated by the drive train.

81. The method of claim 80, wherein the rotation of the second drive train is converted into a second landscape maintenance function.

82. The method of claim 81, wherein the second landscape maintenance function comprises at least one of a reel mower, a reciprocating scythe, a rake, a twirling brush, a rotating feeder, pump, a generator, a fan, a snow blower, a snow thrower, an edger, a rotary blade mower, a rotating brush, and a debris blower.

83. The system of claim 61, wherein the wheels have a diameter of between about twelve inches and about thirty inches.

84. The system of claim 61, wherein the maintenance adaptor comprises at least one of a reel mower, a reciprocating scythe, a rake, a twirling brush, a rotating feeder, a pump, a generator, a fan, a snow blower, an edger, a rotary blade mower, and a rotating brush.
